(19) United States
(12) Patent Application Publication
(10) Pub. No.: US 2016/0063495 A1
(43) Pub. Date: Mar. 3, 2016

(54) Method for Issuing an Assertion of Location

(71) Applicant: INGENICO GROUP, Paris (FR)

(72) Inventor: Michel Leger, Saint Germain En Laye (FR)

(21) Appl. No.: 14/780,935

(22) PCT Filed: Mar. 28, 2014
(86) PCT No.: PCT/EP2014/056377

§ 371 Date: Sep. 28, 2015

(30) Foreign Application Priority Data
Mar. 28, 2013 (FR) 1352846

(51) Int. Cl. G06Q 20/40; G06Q 20/10; H04L 29/08; H04L 29/06

(52) U.S. Cl. CPC G06Q 20/405; H04L 63/105; G06Q 20/108; H04L 67/18

(57) ABSTRACT

A method provides a location assertion for a transaction device that has requested, from a server and via a communication network, acceptance of a financial transaction involving the use of banking information. The method includes: receiving a transaction request from the transaction device, including at least one user identifier with which the banking information is associated; a obtaining an IP address associated with the transaction device; determining a current location associated with the IP address; comparing the current location to at least one authorized location on the basis of the identifier of the user; and providing a location assertion to an entity when the comparison step yields a positive result.

### 1. FIELD OF THE INVENTION

The invention relates to the securing of payments. More particularly, the invention pertains to the securing of online payments.

Online payments represent a growing share of the payments made every day the world over. They can be made either through payment servers such as Paypal™ or through traditional banking organizations.

However, online payment is marked by a relatively high rate of fraud. In France, it is estimated that about five percent of online payments made through the Internet are fraudulent. This figure of five percent of fraudulent payments amounts to about 33% of the total cost of fraud. Means are therefore needed, on the one hand to identify attempts at fraud and, on the other hand, to block these attempts.

The majority of online payments are made with bank cards. These payments require the keying in of a bank card number, a date of validity of this bank card and often a security code which is situated on the back of the card. The cardholder is often advised to make transactions on sites known as “secured” sites in order to make sure that that his details are not stolen. Such sites are called secured sites because they implement at least one session data encryption technique that protects the data exchanged. Unfortunately, the attacks are not often carried out at the time of payment by the cardholder. On the contrary, a standard attack is targeted either against the payment server independently of any transaction or, better still, against the interface between the customer and the bank. These servers are less secured than the session during which the pieces of data are transmitted. They are therefore easier to hack into. Thus, by hacking into these servers, the attackers often have large quantities of bank data which they subsequently use for trade with other persons. These other persons then use this data to carry out fraudulent transactions. One of the problems in online transactions is that they are carried out in “Card Not Present” or CNP mode. In this mode, since there is no device in charge of verifying the integrity of the card (such as for example a payment terminal), it is not necessary to verify that the bearer of the card has the PIN code needed to validate a transaction.

### 2. PRIOR ART

Thus, to try and secure transactions made in CNP mode, systems and methods have been proposed to meet these problems of fraud. These methods raise either practical problems for the user or other problems of security. This is the case for example with the method described in the patent application No. WO2012053780. This patent application describes a system and a method of verification. More particularly, this document describes a method and a system using information on the MAC address of a customer terminal. During a transaction involving a payment, a reinforced authentication process is applied. During this process, the MAC address of the terminal used by the customer wishing to make a payment is compared with a reference MAC address which is defined or obtained by the bank server that has to authorize a payment or a transaction.

Although potentially promising, this method is nevertheless still impractical. Indeed, on the one hand this method obliges the customer to always use the same device to make a payment (unless several devices authorized to make a transaction are defined). Besides, there are many methods by which a MAC address of a device can be falsified. More particularly, the method described in WO2012053780 is based on obtaining a MAC address from a Web browser. Now, a hacker wishing to obtain a user's MAC address would have no difficulty in obtaining this address when he appropriates the payment card details of the user in question, for example by using a method such as is described here above (in attacking a merchant's server). Thus, the method of WO2012053780 would not be of great utility since the complementary information (the MAC address of the transaction device) would be as vulnerable as the others. The method described would therefore have but little chance of truly securing the transaction.

Other methods are also available. In certain methods, the user is given single-use bank card numbers. These numbers are given according to the customer's needs. This method is useful but (fortunately) does not remove the possibility for the customer of using his own card details to carry out transactions. In other methods that are much used at present, an SMS type message is sent to the customer making the transaction in order to make sure that he is truly the bearer of the card. At the time of the transaction, the customer has to enter a password that is transmitted in the SMS. This means that the bank can ensure, with a reasonable degree of probability, that the person making the transaction is truly the bearer of the card. This method suffers from two drawbacks: on the one hand, it obliges the customer to give his phone number to the bank before any transaction and to do so in a secured manner (this is done mostly face-to-face with a personal bank-account manager); on the other hand, this method cannot work unless the customer's bank is also the bank managing the transaction on behalf of the merchant. Now, this is rarely the case, especially abroad. Indeed, a large part of the fraud is carried out abroad. Now, the above-mentioned method is not efficient in this case.

### 3. SUMMARY OF THE INVENTION

The method proposed by the inventors does not pose these problems of the prior art. Indeed, a method is proposed for locating a user making a payment in CNP mode.

More particularly, the invention relates to a method for providing an assertion of location of a transaction device that has requested a server, through a communications network, for acceptance of a financial transaction involving the use of bank details. According to the invention, this method comprises:
a step for receiving a transaction request coming from said transaction device, comprising at least one identifier of a user with whom said bank details are associated;
a step for obtaining an IP address associated with said transaction device;
a step for determining a current location associated with said IP address;
a step for comparing said current location with at least one authorized location, according to said identifier of said user;
a step for providing an assertion of location to an entity when said step for comparing is positive.

Thus, the invention can be used to validate a bank transaction (such as an online payment) on the basis of the location of the terminal conducting the transaction, by using the IP address of this terminal. The proposed method is therefore much simpler and less restrictive in its implementation than methods of authorization based on a MAC address.

According to a particular embodiment, said method further comprises:
a step for obtaining a route taken by data packets to reach said IP address associated with said transaction device, delivering a list of IP addresses used;
a step for associating at least one IP address of said list of IP addresses with at least one location, called a location of transportation;

Thus, the invention makes it possible to plot the path taken by a data packet seeking to reach the IP address associated with the terminal. Additional data is thus obtained to guard against theft or spoofing of an IP address

According to one particular characteristic, said method further comprises:
a step for computing a coefficient of confidence according to coefficients associated with said at least one location of transportation;
and said step for issuing the assertion of location takes account of a threshold of confidence associated with said user.

Thus, the invention makes it possible to classify locations at risk and define thresholds below which the transactions are not accepted.

According to one particular characteristic, said step for issuing the assertion of location is carried out when none of the locations of transportation is part of a list of prohibited locations.

Thus, data packets can be prohibited from passing through prohibited locations. This makes it possible on the one hand to reduce the rate of fraud and, on the other hand, to prevent data from being intercepted even when there does not turn out to be any fraud.

According to one particular embodiment, said method further comprises:
a step for obtaining a current location of a mobile terminal associated with said user;
a step for comparing the current location of the transaction device with the current location of the mobile terminal associated with said user; and
when one of these two locations differs from the other beyond a predetermined parameter of comparison, a step for exiting the validation process without issuance of an assertion of location;
when one of these two locations differs from the other within a predetermined parameter of comparison, a step for exiting the validation process with issuance of an assertion of location.

Thus, the invention enables the location of the transaction terminal to be coupled with the location of another device in the user's possession. This is therefore a dual control that is effective because, in most cases, the transactions are made from the user's home. At home, the probability of the user's mobile terminal being connected to the residential home gateway is high, and in this case the location of terminals will be identical and will be obtained very quickly.

In another embodiment, the invention also relates to a server for providing an assertion of location of a transaction device that has requested a server, through a communications network, for acceptance of a financial transaction involving the use of bank details. According to the invention such a server comprises:
means for receiving a transaction request from said transaction device, comprising at least one identifier of a user with whom said bank details are associated;
means for obtaining an IP address associated with said transaction device;
means for determining a current location associated with said IP address;
means for comparing said current location with at least one authorized location, according to said identifier of said user;
means for providing an entity with an assertion of location when said comparison is positive.

In a preferred embodiment, the various steps of the methods according to the invention are implemented by one or more software or computer programs, comprising software instructions intended for execution by a data processor of a relay module according to the invention and designed to control the execution of the different steps of the methods.

The invention therefore also relates to a program that can be executed by a computer or a data processor, this program comprising instructions for controlling the execution of the steps of a method as mentioned above.

This program can use any programming language whatsoever and take the form of source code, object code or a code that is intermediate between source code and object code, such as in a partially compiled form, or in any other desirable form whatsoever.

The invention also relates to a data carrier readable by a data processor, and comprising instructions of a program as mentioned above.

The information carrier can be any entity or device whatsoever capable of storing the program. For example, the carrier can include storage means, such as a ROM, for example a CD ROM or a microelectronic circuit ROM, or again magnetic recording means, for example a floppy disk or a hard disk drive.

Again, the information carrier can be a transmissible carrier such as an electrical or optical signal which can be conveyed via an electrical or optical cable, by radio or by other means. The program of the invention can, in particular, be downloaded over an Internet-type network.

As an alternative, the information carrier can be an integrated circuit into which the program is incorporated, the circuit being adapted to executing or to being used to execute the method in question.

According to one embodiment, the invention is implemented by means of software and/or hardware components. In this context, the term “module” in this document can correspond equally well to a software component, a hardware component or as a set of hardware and software components.

A software component corresponds to one or more computer programs, one or more subroutines of a program, or more generally to any element of a program or software capable of implementing a function or set of functions, according to what is described below for the module concerned. Such a software component is executed by a data processor of a physical entity (terminal, server, gateway, set-top box, router, etc.) and can access the hardware resources of this physical entity (memory, recording carriers, communications buses, input-output electronic boards, user interfaces, etc.

Similarly, a hardware component corresponds to any element of a hardware assembly capable of implementing a function or set of functions, according to what is described below for the module concerned. It can be a programmable hardware component or a component with an integrated processor for executing software, for example an integrated circuit, a smart card, a memory card, an electronic card for the execution of firmware etc.

Each component of the above-mentioned system naturally implements its own software modules.

The various embodiments described here above can be combined with one another to implement the invention.

### 4. FIGURES

Other features and advantages of the invention shall appear more clearly from the following description of a preferred embodiment, given as a simple, illustrative and non-exhaustive example, and from the appended drawings of which:

FIG. 1 depicts an embodiment of the method for issuing an assertion of location;

FIG. 2 describes an embodiment derived from the method for issuing an assertion of location;

FIG. 3 describes a complementary embodiment of the method for issuing an assertion of location;

FIG. 4 illustrates an architecture of a server capable of implementing a method for issuing an assertion of location;

FIG. 5 illustrates an architecture of a customer device capable of implementing a method for issuing an assertion of location.

### 5. DESCRIPTION OF AN EMBODIMENT

### 5.1. Reminder of the Principle of Invention

As explained earlier, it has been found that, with current solutions, it is not necessarily possible to make sure that payment made comes from the bearer of the card whose details are being used. The purpose of the proposed method is to ensure that, when using credit card data in CNP mode, it is still possible to obtain information about the bearer of the payment card. In short, the goal is to move from a CNP mode to a mode in which the location of the bearer of the card is identified without changing the bearer's habits, in so doing with full discretion.

To this end, the usual steps leading to the validation of the transaction are modified. In at least one embodiment of the proposed method, in addition to the bank details, the IP address from which the transaction is initiated is obtained. In a basic mode, this IP address is compared with an “IP Allow list” of authorized addresses kept by the entity in charge of carrying out payment transactions (this entity can be a bank, a payment institution or an intermediary institution such as a payment service manager).

In a more advanced embodiment, the IP address is not the piece of data used to validate the transaction. In this embodiment, the data that validates or does not validate the transaction is a location. The IP address of the terminal from which the transaction is made is still obtained, but this IP address serves only as a means of obtaining a location. The location becomes the information through which the authorization for the transaction can be issued (i.e. the information by which it is possible to validate the fact that a transaction can be carried out). This embodiment has several advantages. Firstly, this embodiment does away with problems of address translation. Indeed, very often the device used to perform a banking transaction is situated behind a gateway or proxy. Now retrieving an IP address that is exploitable can be a complex matter. Generally, the IP address retrieved is the IP address of the gateway, but this is not guaranteed. Secondly, this embodiment makes it possible not to limit the number of devices that can be used to perform transactions. More specifically, unlike a MAC address, for example, an IP address is often shared by several devices (for example the address of a home gateway is shared by all user devices connected to this home gateway). It is therefore not necessary to retrieve all the MAC addresses of the devices that could be used.

In at least one embodiment, the location used is that of the city of the IP address. In other embodiments, the location can be more specific, for example a street in the city. The accuracy obtained depends on the one hand on the available databases and, on the other hand, on the legal constraints in force in the geographical areas where the invention is being implemented.

We present here below, an implementation of the principle described here above. This implementation is in no way exhaustive and any other implementation comprising the same characteristics as those described is possible.

### 5.2. Description of One Embodiment

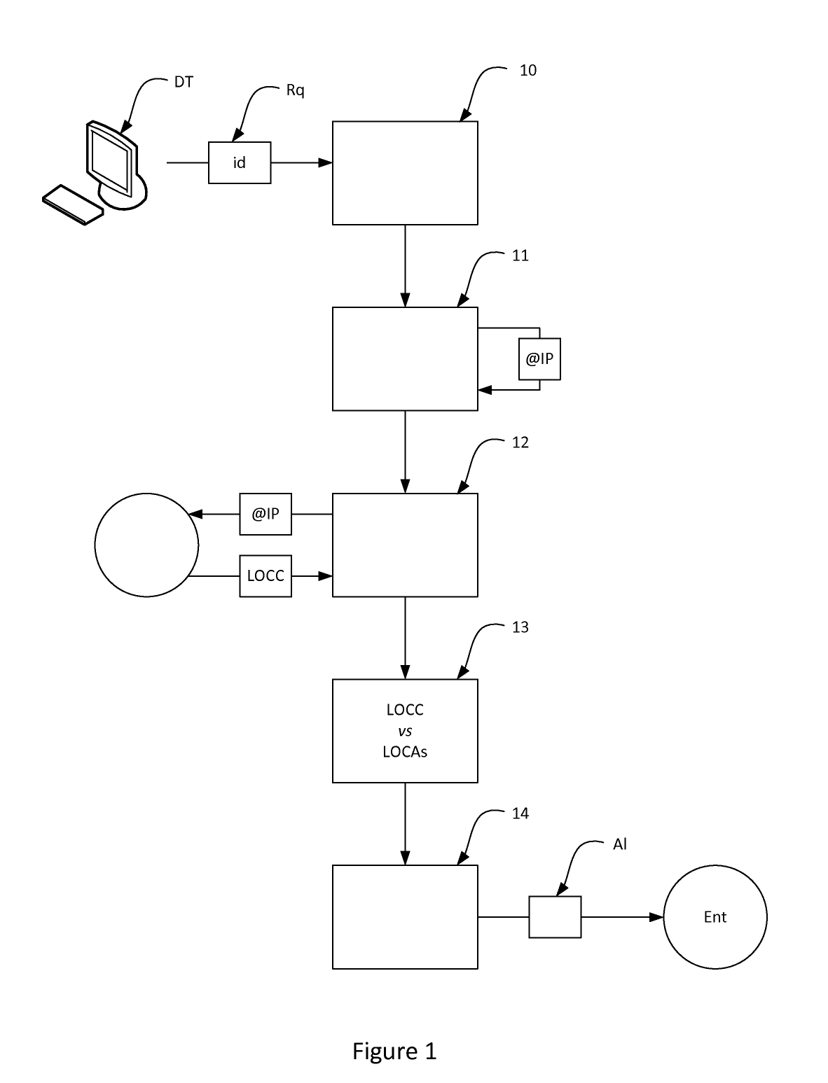

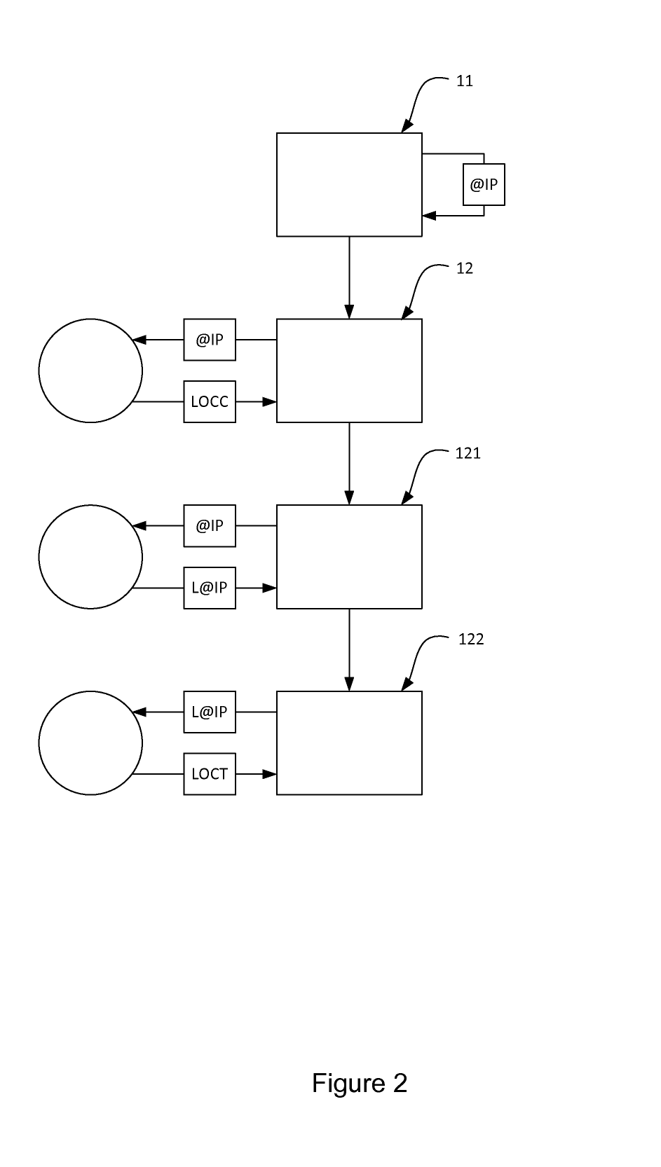

This embodiment, presented with reference to FIGS. 1 and 2, uses the IP address (IP @) of the terminal (Dt) through which the transaction is made. As already stated preliminarily, the terminal through which the transaction is made is not a payment terminal (in the sense of a terminal into which the bank card is inserted and a PIN is entered). This is a terminal such as a computer or a tablet or a smartphone, not a payment terminal such as those installed on merchants' premises.

In this embodiment, the method implemented comprises:
a step for receiving (10) a transaction request (Rq), coming from a transaction device (Dt), comprising at least one identifier (ID) of a user. In this embodiment, it is not necessary for the request in question to include the bank data (card number, transaction amount, etc.), or even for it to come directly from the transaction terminal;
a step for obtaining (11) an IP address (IP @) associated with said transaction device (Dt);
a step for determining (12) a current location (LOCC) associated with said IP address (IP @);
a step for comparing (13) said current location (LOCC) with at least one authorized location (Locas), which is obtained by means of said identifier (id) of said user;
when said current location (LOCC) corresponds to at least one authorized location (LOCAs), a step for issuing (14) an assertion of location (Al) to an entity (Ent).

The assertion of location (Al) is then provided to an entity to validate the bank transaction (this validation of a bank transaction is of course made using other parameters and values that come into the validation process). It can be noted that the entity in question may very well be the one that implements the method just described.

Thus, the method is used to compare the location of the IP address of the terminal initiating the payment with a list of authorized locations. These locations can be defined by the user's bank, automatically. Indeed, it is highly traditional for users to log in to their online bank account management systems from several different locations. Among the users' favorite locations, two are extremely common: these are firstly the user's home and secondly his workplace.

To implement the proposed method, and more particularly, to enable discreet use of the proposed method, it is therefore possible to retrieve the IP addresses of users when they log in to their online banking services. In contrast, in this embodiment, this retrieval is not sufficient per se. It is necessary, after an IP address retrieval, to get a more or less precise location of this address and keep this location as an authorized location. This keeping of the address can be done according to several criteria. For example, when an identified location corresponds to more than 20 percent or 30 percent of all the user's locations (these percentages are given by way of an indication), it can be assumed that this location can be kept. However, when a location does not correspond to a usual location of the user, the location can be excluded from the locations allowed by the bank or payment agency or payment service manager. In this embodiment of the invention, the location is a country, a city or a street (or a combination of these pieces of data.

In one derived embodiment, the current location of the transaction device is further complemented by the implementation of a “trace route” type request. Such a request makes it possible indeed to follow the path taken by an IP packet to reach a given address. In this complementary embodiment, at least some of the IP addresses obtained through the “trace route” request are used to obtain “intermediate” locations. Although this embodiment of the invention more or less significantly lengthens the process of issuing the assertion of location, it makes it possible to evaluate the path taken by packets to reach the IP address of the transaction device. Thus, a list of IP addresses is obtained and at least some of these addresses are associated with a location (for example of the country or city or street type, or a combination of these pieces of data). This list is put in an order so as to be able to assess the distance covered by the packets.

Thus for example, if the locations of the different IP addresses in the list are not consistent with the IP address as received from the transaction device (for example the location of the IP address of the transaction device indicates France whereas while the successive locations on the list are outside France, for example in Russia, Albania, India, China, etc.), it is possible to modulate the issuance of the assertion of location. This modulation may take many forms: either the assertion of location is not at all issued and the process is stopped or a technique based on coefficients of confidence is introduced.

In this technique, countries or regions within a country or even cities and streets are assigned confidence levels. This coefficient is a value smaller than or equal to 1. Each location of the list of successive locations is assigned a coefficient. The coefficients of the locations in the list are multiplied to obtain a confidence level. When the confidence level is below a predetermined threshold of confidence, the assertion of location is not issued.

This confidence threshold can for example depend on the number of bank incidents related to the user or again on the frequency with which the bank has noted that the user has been moving (this is determined from withdrawals made in different countries or in different cities).

In this derived embodiment, the method therefore comprises:
a step (11) for obtaining an IP address (IP @) associated with the transaction device (Dt);
a step (121) for making a request to obtain a route taken by data packets to reach said IP address (IP @) of said transaction device, delivering a list of IP addresses taken) (L @ IP);
a step (122) for associating at least one IP address of said list of IP addresses (IP @ L) with at least one location, called a location of transportation (LOCT); and
   either a step for computing a confidence coefficient according to coefficients associated with said at least one location of transportation and a step for issuing the assertion of location according to a confidence threshold associated with said user;
   or a step for issuing the assertion of location when none of the locations of transportation is part of a list of prohibited locations.

In the description of FIG. 2, the steps presented above are associated with a preliminary determination of a location of IP address of the terminal. This is only one embodiment. It is quite possible to implement these steps independently.

### 5.3. Description of a Second Embodiment

In this second embodiment, the security is reinforced. Indeed, in addition to the location of the place where the transaction is made (for example by using the IP address of the terminal from which the transaction is initiated), the embodiment uses the location of a mobile terminal (for example a smartphone or tablet) in the user's possession to determine the location of this terminal. In other words, in this embodiment, in addition to the location of the terminal from which the transaction is made, it is also sought to locate a mobile device in the user's possession so as to be able to correlate this location of a mobile device with that of the device through which the transaction is performed.

Specifically, when the two locations obtained are not consistent, the assertion of location is not provided and the transaction cannot continue.

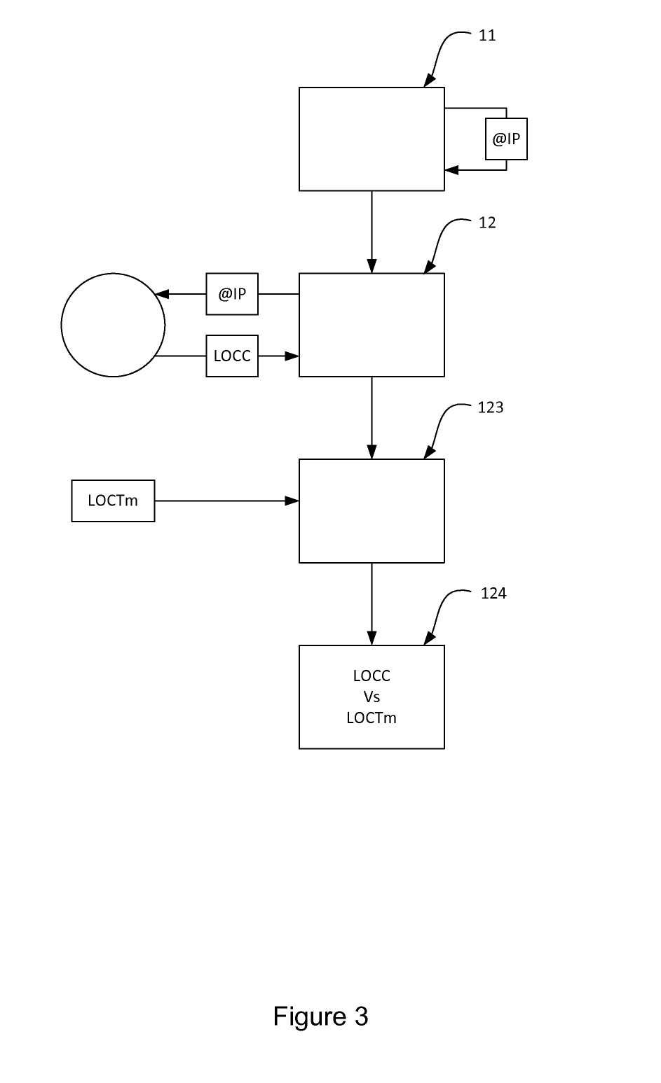

Thus, as compared with the preceding embodiment, the method comprises in addition, referring to FIG. 3:
a step (123) for obtaining a current location of a mobile terminal associated with said user (LOCTm);
a step (124) for comparing the current location of the transaction device (LOCC) with the current location of the mobile terminal associated with said user (LOCTm); and
when one of these two locations differs from the other beyond a predetermined parameter of comparison, a step for exiting the validation process without issuance of an assertion of location;
when one of these two locations differs from the other within a predetermined parameter of comparison, a step for exiting the validation process with issuance of an assertion of location.

Thus, two locations are used and correlated to enable the issuance of the assertion of location.

Depending on the embodiments, the step for obtaining a current location of a mobile terminal associated with said user can include a direct transmission of a location by the terminal itself if the terminal is in a position to make this transmission (for example through a dedicated application: see here below). The location can also be obtained through the communications network to which the communications terminal is connected. As a rule, this entails implementation via the telecommunications operator to which the user has subscribed (this can cause problems as operators are generally reluctant to provide such data which they prefer to keep for their own use or for uses stipulated by the laws of different countries).

### 5.4. Application and Mobile Terminal

As mentioned previously, in at least one embodiment, the method is implemented through a mobile terminal that is assumed to be in the user's possession. Unlike in the known techniques, the method does not consist in transmitting a piece of information to the mobile terminal to verify that the cardholder has his terminal available to carry out the transaction. On the contrary, the method consists in obtaining information from the terminal. This approach is firstly more discreet and secondly does not make unnecessary calls on the user. The information obtained can be of several types. The information can be a geographic position obtained via a geolocation module (of the GPS, GLONASS, Galileo or other type). The information can also be an IP address. This IP address can be the IP address of the gateway to which the terminal is connected, for example by Wi-Fi when the terminal is at the user's home. This IP address can be the one provided by a service provider in the case of Internet connection through a 3G/4G network. Again, the information can be a base station identifier with which the terminal is connected (for example on a 2G/3G/4G network). Thus, via the telephone, one or more pieces of information are obtained, enabling the terminal to be located.

In one specific embodiment of the invention, this implementation is provided by a mobile application. More particularly, according to a preferred embodiment, this application is the user's bank application. Indeed, it is very common for users to have an application allowing them to manage their accounts from their mobile terminals. Generally, this type of application has reinforced security. Specifically, this type of application often uses a session data encryption (SSL or TLS) protocol that ensures a degree of confidentiality for the data transmitted. In one specific embodiment, in which the method of issuance of the assertion of location is carried out by a third party (i.e. not by the user's bank), the mobile application, on request, transmits the necessary data to a bank server, which retransmits this data (or data converted into location data) to the third-party server (for example the transaction server).

### 5.5. Transaction Server

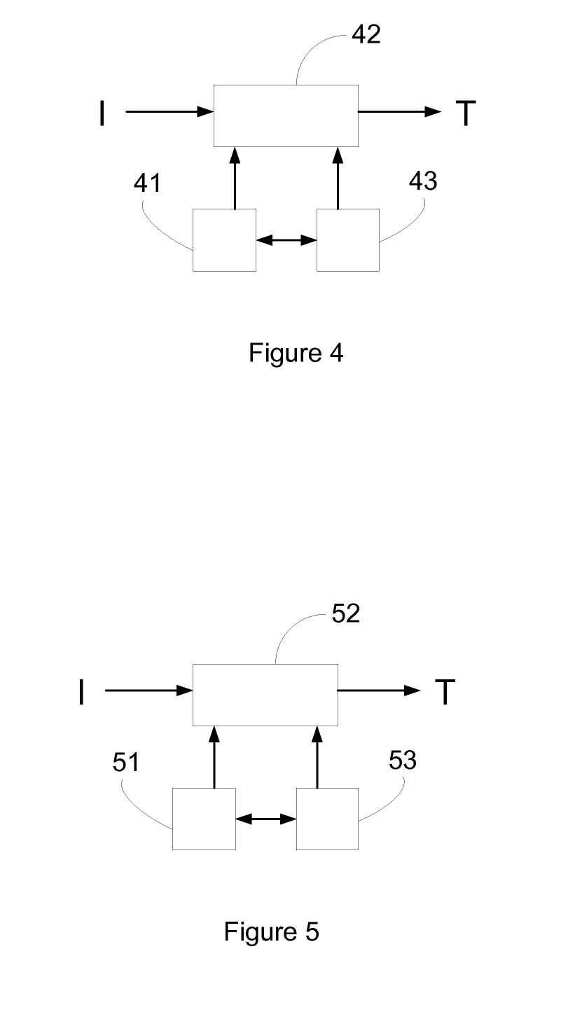

In at least one embodiment, the method described is implemented by means of a transaction server, presented with reference to FIG. 4. Such a server can be implemented either by a banking organization or a payment service provider or a provider acting as an intermediary between one or more banks or payment institutions.

Such a management server comprises a memory 41, a processing unit 42 equipped for example with a microprocessor and driven by the computer program 43 implementing the method according to the invention. In at least one embodiment, the invention is implemented in the form of a bank server or a payment system. Such a server comprises:
means for receiving a transaction application, from said transaction device, comprising at least one identifier of a user with whom said bank details are associated; these means can take the form of a connection interface (I) for connection with one or more communication networks. They may be software interfaces or hardware interfaces (of the network card type or network communications hardware module type).
means for obtaining an IP address associated with said transaction device; these means can be made in the form of a connection interface (I) for connection with one or more communication networks. They may be software interfaces or hardware interfaces (of the network card type or network communications hardware module type);
means for determining a current location associated with said IP address;
means for comparing said current location with at least one authorized location, on the basis of said identifier of said user;
means for supplying an assertion of location to an entity when said comparison is positive. These means can take the form of a connection interface for connection with one or more communication networks. They may be software interfaces or hardware interfaces (of the network card type or network communications hardware module type).

In at least one embodiment, such a server also comprises means for obtaining at least one piece of information from a mobile terminal which is supposed to be in the possession of the user, of whom a transaction is to be validated. In this embodiment, the server can, for example, transmit a request to obtain this information to the mobile terminal. To this end, the server can implement several techniques, the first being for example the transmission of an SMS type message to an application installed in the terminal (see “Application and mobile terminal”).

On receiving the information on location, the server verifies that there is a match between the previously obtained location (that of the terminal to which the user is connected) and the location obtained via the mobile terminal. When these locations are not in agreement, the transaction server does not give any assertion of location and the transaction is cancelled.

Ingeniously, when possible, all the available information (geolocation, IP address and base station identifier) is transmitted by the mobile application to the transaction server and this information is then cross-checked by the transaction server (to which this cross-checking function is added). This cross-checking of information is done by order of reliability of the pieces of information received. For example, the identifier of the base station to which the mobile terminal of the user is connected (2G, 3G, 4G network) is considered to be more reliable than that geolocation which is itself more reliable than the IP address. Thus, when the location obtained through the IP address is different from that obtained through the base station identifier, it can be estimated that the location through the IP address is likely to be less reliable than the location through the network to which the terminal is connected. In this case, it can be decided for example not to authorize a transaction (no assertion of location is issued).

### 5.4. Device for Implementing the Invention

Referring to FIG. 5, a simplified architecture is presented of a mobile device capable of transmitting its position. Such a mobile device comprises a memory 51, a processing unit 52 equipped for example with a microprocessor and controlled by the computer program 53 implementing the method according to the invention. In at least one embodiment, the invention is implemented in the form of a mobile application installed in a mobile device in the user's possession. Such a mobile device comprises:
means for receiving a request to obtain a location coming from a server. These means can take the form of a connection interface for connection with one or more communication networks. They may be software interfaces or hardware interfaces (of the network card type or network communications hardware module type);
means for determining a position, for example by means of a GPS type global positioning interface;
means (T) for transmitting at least one position to said server. These means can take the form of a connection interface for connection with one or more communication networks. They may be software interfaces or hardware interfaces (of the network card type or network communications hardware module type).

1. A method for providing an assertion of location of a transaction device that has requested a transaction server, through a communications network, for acceptance of a financial transaction involving the use of bank details, the method comprising the following steps, performed by a processing unit of a location server:
receiving a transaction request coming from the transaction device, comprising at least one identifier of a user associated with the bank details;
obtaining an IP address associated with the transaction device;
determining a current location associated with the IP address;
comparing the current location with at least one authorized location, according to said identifier of said user and providing an assertion of location to an entity when the comparing is positive;
obtaining a route taken by data packets to reach said IP address associated with said transaction device, delivering a list of IP addresses used;
associating at least one IP address of said list of IP addresses with at least one location, called a location of transportation.

2. The method for providing an assertion of location according to claim 1, further comprising:
computing a coefficient of confidence according to coefficients associated with said at least one location of transportation;
and the providing of the assertion of location takes account of a threshold of confidence associated with said user.

3. The method for providing an assertion of location according to claim 1, wherein the providing of the assertion of location is carried out when none of the locations of transportation is part of a list of prohibited locations.

4. The method for providing an assertion of location according to claim 1, further comprising:
obtaining a current location of a mobile terminal associated with said user;
comparing the current location of the transaction device with the current location of the mobile terminal associated with said user; and
when one of these two locations differs from the other beyond a predetermined parameter of comparison, exiting validation process of the financial transaction without issuance of an assertion of location;
when one of these two locations differs from the other within a predetermined parameter of comparison, exiting the validation process with issuance of an assertion of location.

5. A location server for providing an assertion of location of a transaction device that has requested a transaction server, through a communications network, for acceptance of a financial transaction involving the use of bank details, the location server comprising:
means for receiving a transaction request from said transaction device, comprising at least one identifier of a user with whom said bank details are associated;
means for obtaining an IP address associated with said transaction device;
means for determining a current location associated with said IP address;
means for comparing said current location with at least one authorized location, according to said identifier of said user;
means for providing an entity with an assertion of location when said comparison is positive,
means for obtaining a route taken by data packets to reach said IP address associated with said transaction device, delivering a list of IP addresses used;
means for associating at least one IP address of said list of IP addresses with at least one location, called a location of transportation.

6. A non-transitory computer-readable medium comprising a computer program product stored thereon and executable by a microprocessor, wherein the program product comprises program code instructions to execute a method for providing an assertion of location of a transaction device that has requested a transaction server, through a communications network, for acceptance of a financial transaction involving the use of bank details, when the instructions are executed on a computer, the method comprising:
receiving a transaction request coming from the transaction device), comprising at least one identifier of a user associated with the bank details;
obtaining an IP address associated with the transaction device;
determining a current location associated with the IP address;
comparing the current location with at least one authorized location, according to said identifier of said user and providing an assertion of location to an entity when the comparing is positive;
obtaining a route taken by data packets to reach said IP address associated with said transaction device, delivering a list of IP addresses used;
associating at least one IP address of said list of IP addresses with at least one location, called a location of transportation.
